(19) United States
(12) Patent Application Publication
(10) Pub. No.: US 2007/0230283 A1
(43) Pub. Date: Oct. 4, 2007

(54) Date range determination for cached date driven values

(75) Inventors: Frank J. Castaneda, Raleigh, NC (US); David L. Zanter, Durham, NC (US)

Correspondence Address: CAREY, RODRIGUEZ, GREENBERG & PAUL, LLP;STEVEN M. GREENBERG, 950 PENINSULA CORPORATE CIRCLE, SUITE 3020, BOCA RATON, FL, 33487, US

(73) Assignee: International Business Machines Corporation, Armonk, NY (US)

(21) Appl. No.: 11/392,137

(22) Filed: Mar. 29, 2006

(51) Int. Cl. G04C 17/00

(52) U.S. Cl. 368/29

(57) ABSTRACT

Embodiments of the present invention address deficiencies of the art in respect to filtering and caching recurring date driven data and provide a method, system and computer program product for data range determination for cached date driven values. In one embodiment of the invention, a date driven date selective retrieval method for recurrences in date driven data can include defining a date range, retrieving exactly three cached instances for each of the recurrences in the date driven data, selecting only those recurrences that fall within the date range according to the three cached instances for each of the recurrences, and adding the selected recurrences to a subset of the date driven values, and otherwise excluding remaining ones of the recurrences from the subset.

### BACKGROUND OF THE INVENTION

1. Field of the Invention

The present invention relates to date related event management and more particularly to recurring event management.

2. Description of the Related Art

Date management refers to the scheduling of events according to an occurrence date, time or both. Often discussed in the context of calendaring systems and personal information managers, date management extends beyond calendaring systems to include scheduling systems in general in which events or tasks are scheduled to occur at a particular date or time. Even management logic minimally can include a view to a sequence of events or tasks scheduled to occur at a particular date or time. Generally, the event or task can be associated with a textual description of the event or task. More advanced implementations also permit the association of the scheduled event with a particular contact, a particular project, or both.

Several software products include support for Calendaring & Scheduling (C&S). Known C&S products include Lotus Notes, Microsoft Outlook, and web-based products like Yahoo! Calendar. These products allow one to manage personal events including appointments and anniversaries. C&S products also typically allow one to manage shared events, referred to generally as meetings. Notably, many C&S products as well as other date management systems include the concept of repeating events. The creation of repeating events is generally straightforward. The user interface permits one to define the first instance of the repeating series and to specify how the series repeats. The definition of a repeating series often is referred to as a “recurrence rule”.

More specifically, an important feature of a date management system includes the ability to schedule a recurring event without requiring the end user to individually set an event on each recurring date. For example, where a meeting is to occur every week on a particular time over the course of several months, the end user can schedule the event as recurring every week at the particular time for the course of the several months. The date management system, in turn, can schedule each event in an automated fashion based upon the recurrence pattern. Advantageously, the end user subsequently can modify any one of the recurring events, or the end user can apply a single modification to all of the recurring events responsive to which the date management system can apply the single modification to all of the recurring events in an automated fashion.

When deployed in the enterprise, a date management system can require the interoperation of basic date management with the functionality of the enterprise. Synchronization of date driven data in different client computing devices represents an important aspect of the functionality of the enterprise. In many cases, data synchronized within the enterprise can be limited to a data subset filtered by date. Computing the subset can be complicated and resource consuming where the filter is complex or where the data set is large. To compound matters, date driven data conforming to a recurrence rule can further complicate synchronization. To accelerate the process of synchronization, oftentimes, the computed subset of date driven data driven by a filter can be cached for later use. Managing the caching of date driven data conforming to a recurrence rule, however, can even yet further complicate matters.

### BRIEF SUMMARY OF THE INVENTION

Embodiments of the present invention address deficiencies of the art in respect to filtering and caching recurring date driven data and provide a novel and non-obvious method, system and computer program product for data range determination for cached date driven values. In one embodiment of the invention, a date driven date selective retrieval method for recurrences in date driven data can include defining a date range, retrieving exactly three cached instances for each of the recurrences in the date driven data, selecting only those recurrences that fall within the date range according to the three cached instances for each of the recurrences, and adding the selected recurrences to a subset of the date driven values, and otherwise excluding remaining ones of the recurrences from the subset.

Defining the date range can include defining a date range as bounded by an earliest point in time (LW) and a latest point in time (RW). As such, retrieving exactly three cached instances for each of the recurrences in the date driven data can include retrieving a first cached instance in the recurrence (V1) that occurs before a designated point in the date range, a first instance in the recurrence that occurs after the designated point (V2), and a last instance in the recurrence (V3). Selecting only those recurrences that fall within the date range according to the three cached instances for each of the recurrences can include selecting recurrences having a V2 that is later than the LW of the date range, further selecting recurrences having a V3 that is later than the LW of the date range and earlier than the RW of the date range, and deferring a selection of all other recurrences to a full evaluation.

Notably, retrieving exactly three cached instances for each of the recurrences in the date driven data can include identifying a special circumstance where the first instance of the recurrence that occurs after the designated point is the last instance of the recurrence, and retrieving the last three instances of the recurrence. Similarly, retrieving exactly three cached instances for each of the recurrences in the date driven data can include identifying another special circumstance where the first instance of the recurrence that occurs before the designated point is the last instance of the recurrence, and retrieving the last three instances of the recurrence. Yet further, retrieving exactly three cached instances for each of the recurrences in the date driven data can include identifying yet another special circumstance where the first instance of the recurrence occurs after the designated point, and retrieving the first two instances and the last instance of the recurrence.

In another embodiment of the invention, a data processing system can be configured for date driven data management. The data processing system can include a data store of date driven values and a cache of recurrence instances, the cache including exactly three instances for each recurrence among the date driven values in the data store. For instance, the date driven values can include time/date sensitive instances such as events, tasks, electronic mail, and inventory. Finally, the system can include date range determination logic. The logic can include program code enabled to filter the date recurrences in a filtered subset to meet an established date range utilizing only the three instances for each recurrence in the cache.

Additional aspects of the invention will be set forth in part in the description which follows, and in part will be obvious from the description, or may be learned by practice of the invention. The aspects of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE SEVERAL VIEWS OF THE DRAWINGS

The accompanying drawings, which are incorporated in and constitute part of this specification, illustrate embodiments of the invention and together with the description, serve to explain the principles of the invention. The embodiments illustrated herein are presently preferred, it being understood, however, that the invention is not limited to the precise arrangements and instrumentalities shown, wherein:

FIG. 1 is a schematic illustration of a client-server data processing system configured to synchronize cached date driven values to client computing devices over a communications medium; and,

FIG. 2 is a flow chart illustrating a process for generating a filtered subset of date driven values for caching in the system of FIG. 1.

### DETAILED DESCRIPTION OF THE INVENTION

Embodiments of the present invention provide a method, system and computer program product for date range determination of cached date driven values. In accordance with an embodiment of the present invention, three date driven values can be cached for each recurrence. The three date driven values can include the first instance in the recurrence that occurs before a designated time or date, the first instance in the recurrence that occurs after the designated time or date, and the last instance in the recurrence. Subsequently, a filter can be applied to the three cached values exclusively to determine whether or not to include the entire recurrence in a subset of the date driven values, or whether a full evaluation of the recurrence is required.

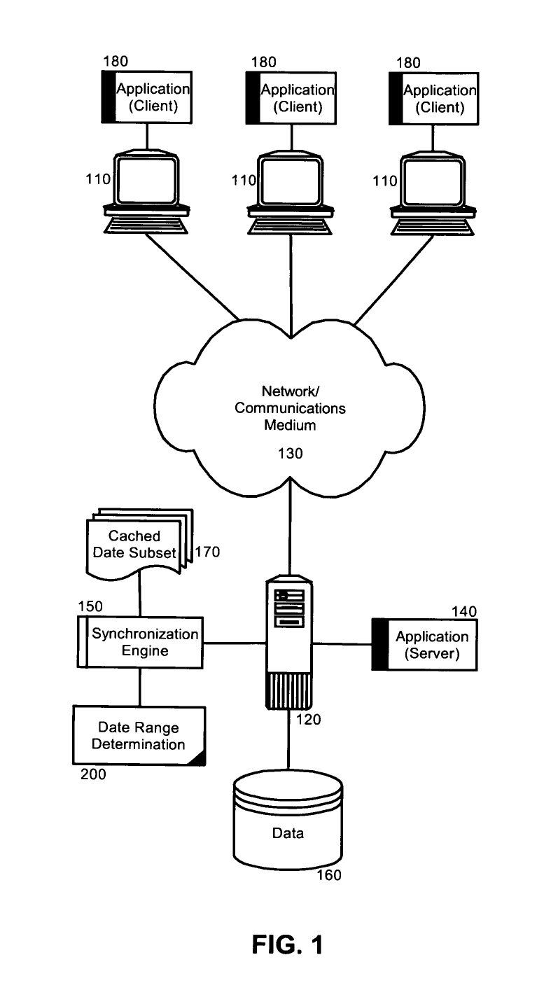

Notably, the date range determination can be applied to the synchronization of the subset to client computing devices over a communications medium. In further illustration, FIG. 1 is a schematic illustration of a client-server data processing system configured to synchronize cached date driven values to client computing devices over a communications medium. As shown in FIG. 1, the data processing system can include a host computing platform 120 coupled to one or more client computing devices 110 over a communications medium 130 that can range from a direct, serial link (either wireless or wire bound), to a data communications network such as the global Internet.

The host computing platform 120 can support the operation of a server portion of an application 140 which can operate upon date driven data 160. Each of the client computing devices 110, in turn, can support the operation of a client portion 180 of the application 140. To that end, a synchronization engine 150 can be coupled to the host computing platform 120 and the server portion of the application 140 to manage the synchronization of a filtered subset of the date driven data 160 to the client portions 180 of the application 140 over the communications medium 130.

Importantly, date range determination logic 200 can be coupled to the synchronization engine 150 and to the host computing platform 120. The date range determination logic 200 can include computer program code enabled to process each recurrence among the date driven data 160 to filter those recurrences required to meet a specified date range. To facilitate the filtering process, three values for each recurrence can be disposed in a cache 170 which values can be used to properly filter the date driven data 160 for synchronization.

The cached values within the cache 170 for each recurrence can include the first instance in the recurrence (V1) that occurs before a designated time or date (such as the then current time or date), the first instance in the recurrence that occurs after the designated time or date (V2), and the last instance in the recurrence (V3). In the special circumstance where the first instance of the recurrence that occurs after the designated time is the last instance of the recurrence, then the last three instances of the recurrence can be cached. Likewise, in the special circumstance where the first instance of the recurrence that occurs before the designated time is the last instance of the recurrence, then the last three instances of the recurrence can be cached. Finally, in another special circumstance where the first instance of the recurrence occurs after the designated time, then the first two instances and the last instance of the recurrence can be cached.

Subsequently, the filter can be applied to the three cached values exclusively to determine whether or not to include the entire recurrence in a subset of the date driven values, or whether a full evaluation of the recurrence is required. Utilizing only the three cached values, recurrences that can be safely ignored can be filtered out efficiently without incurring processing overhead, whereas only a small grouping of recurrences can require a full evaluation under the filter. Consequently, resources can be conserved in the synchronization process.

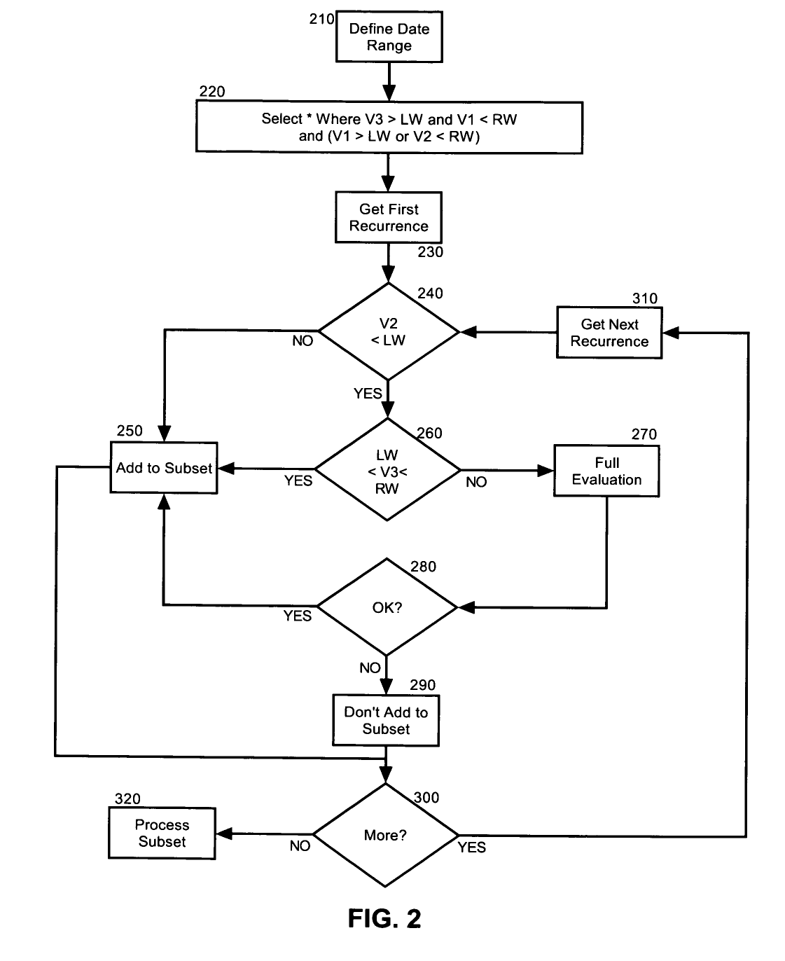

In yet further illustration of the operation of the date range determination logic, FIG. 2 is a flow chart illustrating a process for generating a filtered subset of date driven values cached in the system of FIG. 1. Beginning in block 210, a date range can be defined to be bounded by an earliest point in time (LW) and a latest point in time (RW). In block 220, the three cached values, V1, V2 and V3 for all recurrences among the date driven data can be selected where V3 is later than LW, where V1 is earlier than RW, and where either V1 is later than LW or where V2 is earlier than RW. Thereafter, in block 230, a first recurrence in the selection can be selected for processing.

In decision block 240, if for the selected recurrence V2 is determined not to occur before LW, then the selected recurrence can be added to a subset of date driven data in block 250. Otherwise, in decision block 260, if V3 falls between LW and RW, then the selected recurrence can be added to the subset of date driven data in block 250. Otherwise, the selected recurrence can be flagged for full evaluation in block 270. In decision block 280, if the selected recurrence is determined to be added to the subset, in block 250 the selected recurrence can be added to a subset of date driven data. Otherwise, the selected recurrence excluded from the subset of date driven data in block 290.

Thereafter, in decision block 300, if additional recurrences remain to be evaluated, in block 310 a next recurrence can be selected for processing and the method can repeat through block 240. When no further recurrences remain to be process in the cache in decision block 300, in block 320 filtered subset can be provided for processing. As an example, a synchronization engine can utilize the filtered subset in performing a synchronization of date driven data, such as events, to-dos, inventory aging, and generally any other types of values that are date driven.

Embodiments of the invention can take the form of an entirely hardware embodiment, an entirely software embodiment or an embodiment containing both hardware and software elements. In a preferred embodiment, the invention is implemented in software, which includes but is not limited to firmware, resident software, microcode, and the like. Furthermore, the invention can take the form of a computer program product accessible from a computer-usable or computer-readable medium providing program code for use by or in connection with a computer or any instruction execution system.

For the purposes of this description, a computer-usable or computer readable medium can be any apparatus that can contain, store, communicate, propagate, or transport the program for use by or in connection with the instruction execution system, apparatus, or device. The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution. Input/output or I/O devices (including but not limited to keyboards, displays, pointing devices, etc.) can be coupled to the system either directly or through intervening I/O controllers. Network adapters may also be coupled to the system to enable the data processing system to become coupled to other data processing systems or remote printers or storage devices through intervening private or public networks. Modems, cable modem and Ethernet cards are just a few of the currently available types of network adapters.

We claim:

1. A date driven date selective retrieval method for recurrences in date driven data, the method comprising:
defining a date range;
retrieving exactly three cached instances for each of the recurrences in the date driven data;
selecting only those recurrences that fall within the date range according to the three cached instances for each of the recurrences; and,
adding the selected recurrences to a subset of the date driven values, and otherwise excluding remaining ones of the recurrences from the subset.

2. The method of claim 1, wherein defining the date range comprises defining a date range as bounded by an earliest point in time (LW) and a latest point in time (RW).

3. The method of claim 2, wherein retrieving exactly three cached instances for each of the recurrences in the date driven data, comprises:
retrieving a first cached instance in the recurrence (V1) that occurs before a designated point in the date range;
retrieving a first instance in the recurrence that occurs after the designated point (V2); and,
retrieving a last instance in the recurrence (V3).

4. The method of claim 3, wherein retrieving exactly three cached instances for each of the recurrences in the date driven data, comprises:
identifying a special circumstance where the first instance of the recurrence that occurs after the designated point is the last instance of the recurrence; and,
retrieving the last three instances of the recurrence.

5. The method of claim 3, wherein retrieving exactly three cached instances for each of the recurrences in the date driven data, comprises:
identifying a special circumstance where the first instance of the recurrence that occurs before the designated point is the last instance of the recurrence; and,
retrieving the last three instances of the recurrence.

6. The method of claim 3, wherein retrieving exactly three cached instances for each of the recurrences in the date driven data, comprises:
identifying a special circumstance where the first instance of the recurrence occurs after the designated point; and,
retrieving the first two instances and the last instance of the recurrence.

7. The method of claim 3, wherein selecting only those recurrences that fall within the date range according to the three cached instances for each of the recurrences, comprises:
evaluating only a group of the recurrences having a V3 that is later than LW and a V1 that is earlier than RW and either a V1 that is later than LW or a V2 that is earlier than RW;
selecting recurrences from the group having a V2 that is later than the LW of the date range;
further selecting recurrences from the group having a V3 that is later than the LW of the date range and earlier than the RW of the date range; and,
deferring a selection of all other recurrences from the group to a full evaluation.

8. The method of claim 1, further comprising performing a synchronization of the subset with at least one communicatively coupled client computing device.

9. A data processing system configured for date driven data management, the system comprising:
a data store of date driven values;
a cache of recurrence instances, the cache comprising exactly three instances for each recurrence among the date driven values in the data store; and,
date range determination logic comprising program code enabled to filter the date recurrences in a filtered subset to meet an established date range utilizing only the three instances for each recurrence in the cache.

10. The system of claim 9, wherein the date driven values comprise time/date sensitive instances selected from the group consisting of events, tasks, electronic mail, and inventory.

11. The system of claim 9, wherein the three instances for each recurrence comprise:
a first cached instance in the recurrence (V1) that occurs before a designated point in the date range;
a first instance in the recurrence that occurs after the designated point (V2); and,
a last instance in the recurrence (V3).

12. The system of claim 9, further comprising a synchronization engine configured to synchronize the filtered subset with a plurality of communicatively coupled client devices.

13. A computer program product comprising a computer usable medium embodying computer usable program code for date driven date selective retrieval for recurrences in date driven data, the computer program product including:
computer usable program code for defining a date range;
computer usable program code for retrieving exactly three cached instances for each of the recurrences in the date driven data;
computer usable program code for selecting only those recurrences that fall within the date range according to the three cached instances for each of the recurrences; and,
computer usable program code for adding the selected recurrences to a subset of the date driven values, and otherwise excluding remaining ones of the recurrences from the subset.

14. The computer program product of claim 13, wherein the computer usable program code for defining the date range comprises computer usable program code for defining a date range as bounded by an earliest point in time (LW) and a latest point in time (RW).

15. The computer program product of claim 14, wherein the computer usable program code for retrieving exactly three cached instances for each of the recurrences in the date driven data, comprises:
computer usable program code for retrieving a first cached instance in the recurrence (V1) that occurs before a designated point in the date range;
computer usable program code for retrieving a first instance in the recurrence that occurs after the designated point (V2); and,
computer usable program code for retrieving a last instance in the recurrence (V3).

16. The computer program product of claim 15, wherein the computer usable program code for retrieving exactly three cached instances for each of the recurrences in the date driven data, comprises:
computer usable program code for identifying a special circumstance where the first instance of the recurrence that occurs after the designated point is the last instance of the recurrence; and,
computer usable program code for retrieving the last three instances of the recurrence.

17. The computer program product of claim 15, wherein the computer usable program code for retrieving exactly three cached instances for each of the recurrences in the date driven data, comprises:
computer usable program code for identifying a special circumstance where the first instance of the recurrence that occurs before the designated point is the last instance of the recurrence; and,
computer usable program code for retrieving the last three instances of the recurrence.

18. The computer program product of claim 15, wherein the computer usable program code for retrieving exactly three cached instances for each of the recurrences in the date driven data, comprises:
computer usable program code for identifying a special circumstance where the first instance of the recurrence occurs after the designated point; and,
computer usable program code for retrieving the first two instances and the last instance of the recurrence.

19. The computer program product of claim 15, wherein the computer usable program code for selecting only those recurrences that fall within the date range according to the three cached instances for each of the recurrences, comprises:
computer usable program code for evaluating only a group of the recurrences having a V3 that is later than LW and a V1 that is earlier than RW and either a V1 that is later than LW or a V2 that is earlier than RW;
computer usable program code for selecting recurrences from the group having a V2 that is later than the LW of the date range;
computer usable program code for further selecting recurrences from the group having a V3 that is later than the LW of the date range and earlier than the RW of the date range; and,
computer usable program code for deferring a selection of all other recurrences from the group to a full evaluation.

20. The computer program product of claim 13, further comprising computer usable program code for performing a synchronization of the subset with at least one communicatively coupled client computing device.
